(19) United States
(12) Patent Application Publication
(10) Pub. No.: US 2010/0079559 A1
(43) Pub. Date: Apr. 1, 2010

(54) Fluid Circulation System

(76) Inventors: Greg Justice, Vancouver, WA (US); Chris Arnold, Vancouver, WA (US); Patrick Therien, Camas, WA (US); Dan Dowell, Albany, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/240,616

(22) Filed: Sep. 29, 2008

(51) Int. Cl. B41J 2/175

(52) U.S. Cl. 347/85

(57) ABSTRACT

Various apparatus and methods are disclosed in which fluid is circulated across one or more print heads.

This application claims the benefit of U.S. Provisional patent application Ser. No. 61/053254 filed on 15 May 2008, which is hereby incorporated by reference in its entirety.

### BACKGROUND

Many printing systems print fluids onto print media. Such fluids may contain pigments or particles that may settle over time and damage the printing system or reduce printing performance.

### BRIEF DESCRIPTION OF THE DRAWINGS

FIG. 1 is a schematic, illustration of a printing system during tilling of a reservoir according to an example embodiment.

FIG. 2 is a schematic illustration of the printing system of FIG. 1 during printing according to an example embodiment.

FIG. 3 is a schematic illustration of the printing system of FIG. 1 illustrating a valve closing a froth conduit according to an example embodiment.

FIG. 4 is a schematic illustration of the printing system of FIG. 1 during circulation of fluid through a print cartridge according to an example embodiment.

FIG. 4A is a cross-sectional view of an example embodiment of a fluid supply of the printing system of FIG. 1 illustrating fluid circulation across a print head assembly according to an example embodiment

FIG. 5 is a schematic illustration of another embodiment of the printing system of FIG. 1 according to an example embodiment.

FIG. 6 is a schematic illustration of another embodiment of the printing system of FIG. 1 according to an example embodiment.

### DETAILED DESCRIPTION OF THE EXAMPLE EMBODIMENTS

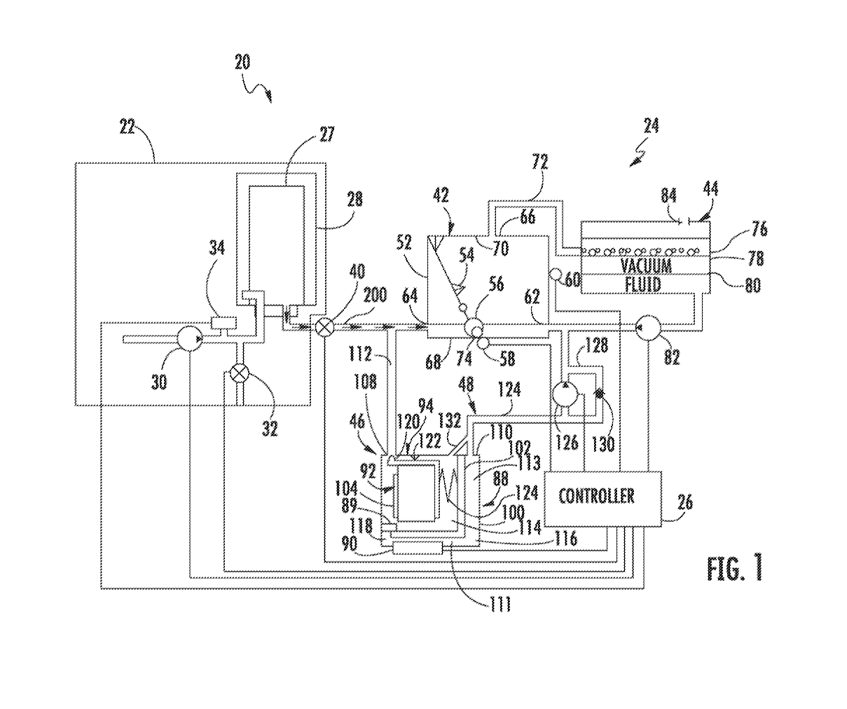

FIG. 1 schematically illustrates printing system 20 according to one example embodiment. As will be described hereafter, printing system 20 is configured to print or deposit fluid onto a print medium while separating the fluid from entrained air and reducing pigment or particle settling. Printing system 20 includes fluid supply 22, fluid recirculation and printing system 24 and controller 26.

Fluid supply 22 comprises a device configured to supply fluid, such as ink, to fluid recirculation and printing system 24. In the example illustrated, fluid supply 22 is configured to supply fluid under a controlled pressure to system 24. In the example illustrated, fluid supply 22 comprises an automatic pressure system which includes supply bag 27, pressurized supply container 28, pump 30, purge valve 32, pressure sensor 34 and controller 26. Supply bag 27 comprises a flexible container or bag containing fluid to be supplied by supply 22. Supply bag 27 is connected to a valve 40. When valve 40 is open, fluid from supply bag 27 as supplied under a relatively constant controlled pressure to system 24.

Pressurized supply container 28 comprises a container at least partially enclosing fluid bag 27. Container 28 is configured to receive pressurized air (or fluid) so as to squeeze bag 27 to force fluid within bag 27 towards valve 40. In other embodiments, other mechanisms may be used to squeeze or otherwise reduce the volume of bag 27.

Pump 30 comprises a pump configured to pump fluid or air into container 28 so as to apply pressure to bag 27 and force fluid from bag 27. Valve 32 comprises a valve configured to selectively permit air (or other fluid) to be purged from container 28 to reduce the amount of pressure being applied against bag 27 and against the fluid contained within bag 27. Pump 30 and valve 32, both operating under the control of controller 26, facilitate the adjustment of pressure within container 28 to adjust the pressure which fluid is supplied from bag 27 and supply 22.

Sensor 34 comprises a sensing device configured a sense the pressure within container 28. Sensor 34 communicates pressure readings to controller 26. Based upon such readings, controller 26 may adjust the pumping of air by pump 30 or the release or purging of air bivalve 32 to control the pressure within container 28 to a desired level. In other embodiments, fluid supply 22 may comprise other devices configured to supply fluid under a controlled or adjustable pressure. For example, in other embodiments, a gravity feed system with a solenoid valve may alternatively be used. In still other embodiments, fluid supply 22 may alternatively be configured to supply fluid to system 24 without such control of the pressure at which the fluid is supplied.

Fluid printing and circulating system 24 receives fluid from supply 22, upon opening a valve 40, and deposits or prints such fluid onto a print medium or substrate. System 24 further circulates such fluid so as to inhibit the settling of particles or pigments at undesirable locations where the settled pigments or particles may reduce print quality achieved by system 20. For example, pigments or particle settling from the fluid may reduce optical density of the fluid, such as ink, and may clog nozzles of the printing system. System 24 also separates air that may have become entrained in the fluid to further enhance printing performance. System 24 generally includes air-fluid separator 42, froth removal system 44, print cartridge 46 and recirculation system 48.

Air-fluid separator 42 comprises an arrangement of components configured to temporarily store fluid while permitting air and froth from the fluid to be separated and to be further directed to froth removal system 44. Separator 42 further supplies fluid to print cartridge 46 for printing after the amount of air within the fluid has been reduced. Separator 42 includes fluid reservoir 52, valve 54, actuator 56 and level sensors 58, 60.

Fluid reservoir 52 comprises a chamber in which the fluid is contained as air is separated from the fluid. Fluid reservoir 52 includes ports 62, 64 and 66. Port 62 comprises a fluid opening in fluid communication with or fluidly connected to froth removal system 44 and recirculation system 48. Port 62 directs fluid into reservoir 52 from froth removal system 44 and recirculation system 48.

In the example illustrated, port 62 is located proximate to a floor 68 of reservoir 52. As a result, fluid returning to reservoir 52 is less likely to pass through air and is less likely to entrain additional air. In other embodiments, port 62 may be located in other positions.

Port 64 comprises a fluid opening in reservoir 52 which is in fluid communication with fluid supply 22 and print cartridge 46. Port 64 directs fluid from fluid supply 22 into reservoir 52. At other times, Port 64 directs fluid from reservoir 52 to print cartridge 46. In the example illustrated, port 64 is located proximate to floor 68 of reservoir 52. As a result, fluid flowing into reservoir 52 is less likely to pass through air and is less likely to entrain additional air. Fluid flow out of reservoir 52 to print cartridge 46 is further assisted by gravity. In other embodiments, port 64 may be located in other positions. For example, in other embodiments, port 64 may alternatively be only connected to print cartridge 46 in embodiments where fluid from supply 22 enters fluid reservoir 52 through a different port, such as port 62, or another port. In such an embodiment, fluid is only discharged from reservoir 52 through port 64.

Port 66 comprises a fluid opening in reservoir 52 proximate to a ceiling 70 of reservoir 52. Port 66 is in fluid communication with froth removal system 44. Port 66 directs air and troth that has risen from the underlying fluid to froth removal system 44 via conduit 72. Although port 66 is illustrated as being located along the ceiling 70, in other embodiments, port 66 may be located along the sides of reservoir 52 proximate the ceiling 50.

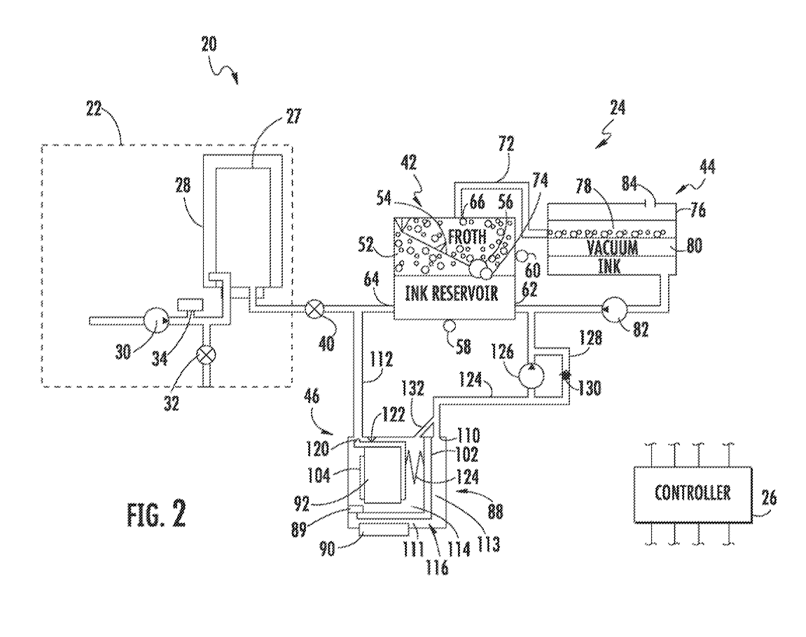

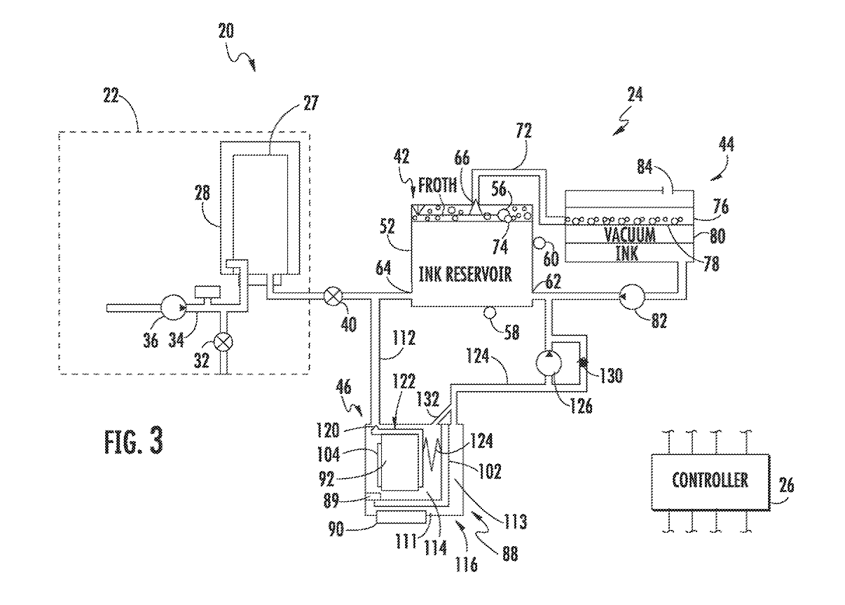

Valve 54 comprises a mechanism configured to selectively open and close port 66 to inhibit or prevent the flow of fluid through conduit 72 and out of reservoir 52 in circumstances where reservoir 52 may be overfilled with fluid. In the example illustrated, valve 54 comprises a plug or stopper that is movable between an open position or state (shown in FIGS. 1 and 2) and a closed position or state (shown in FIG. 3). When valve 54 is in the open state, air and froth is permitted to flow through port 66 to removal system 44. When valve 54 is in the closed state, port 66 is sealed to prevent or inhibit the flow of fluid through conduit 72. In the example illustrated, valve 54 pivots between the open stale and the closed state. In other embodiments, valve 54 may move or actuate between the open state and the closed states in other manners.

Actuator 56 comprises a mechanism configured to move valve 54 between the open state and the closed state. Actuator 56 moves between such states based upon a level of fluid within reservoir 52.

In the example illustrated, actuator 56 comprises a float coupled to valve 54. As the level of fluid within reservoir 52 rises or falls, the float also rises or falls, raising or lowering valve 54. In other embodiments, other mechanisms or actuators may be used to move valve 54 between the open state and the closed state. For example, in other embodiments, powered actuators may alternatively be employed, wherein the powered actuators move valve 54 in response to the sense level of fluid within reservoir 52. In other embodiments, valve 54 and actuator 56 may be omitted.

Level sensors 58, 60 comprise and see mechanisms configured to detect the level of fluid within reservoir 52. In the example illustrated, sensors 58 and 60 comprises switches which are actuated in response to being with insufficient proximity to a corresponding sensor element 74 coupled to the float of actuator 56 so as to move with the float of actuator 56. Sensor 58 is located relative to reservoir 52 so as to be triggered or tripped when the fluid level within reservoir 52 is sufficiently low such that it needs replenishment from supply 22 or such that recirculation of fluid should be halted. Sensor 60 is located relative to reservoir 52 so as to be triggered or tripped when the fluid level within reservoir 52 is sufficiently high such that the flow of fluid into reservoir 52 from supply 22 may be stopped. In the example illustrated, sensor 60 is located sufficiently low so as to provide a volume for the collection of froth above the fluid within reservoir 52.

In one embodiment, sensors 58, 60 and sensor element 74 may comprise a switch sensor such as a Hall-effect sensor. In other embodiments, other sensing switches may be employed. In yet other embodiments, rather than comprising switches that are tripped at predetermined heights of fluid, sensors 58 and 60 may be replaced with one or more other sensors which continuously detect a full range of different heights or levels of fluid within reservoir 52. In still other embodiments, sensors 58, 60 and sensor element 74 may be omitted.

Froth removal system 44 comprises a mechanism configured to facilitate the separation or breakdown of froth into fluid (liquid) and air. Froth removal system 44 receives froth through conduit 72. System 44 vents the separated air and directs the separated fluid back to fluid reservoir 52.

In the example illustrated, froth removal system 44 comprises container 76, filter screen 78, vacuum 80 and pump 82. Container 76 comprises a chamber configured to contain the froth and the remaining opponents of system 44. Container 76 includes vent opening 84 located proximate to a top of container 76 through which separated air is vented or permitted to escape.

Filter screen 78 comprises a screen, membrane or filter extending across an interior of container 76. Filter screen 78 has openings sufficiently small so as to breakdown froth bubbles, wherein air from the froth bubbles rise while fluid from the froth bubbles descends. Vacuum 80 comprises a vacuum source located below filter screen 78 to further assist in drawing froth against filter screen 78 so as to breakdown such froth. As shown in FIG. 1, the separated fluid collects at the bottom of container 76 and is pumped back to fluid reservoir 52 by pump 82.

In other embodiments, vacuum 80 may be omitted. In other embodiments, pump 82 may be omitted, where gravity is used to direct the fluid back to reservoir 52. In still other embodiments, froth removal system 44 may have other configurations or may be omitted.

Print cartridge 46 comprises a device configured to deposit fluid (liquid) onto a print medium or substrate. Print cartridge 46 further permits fluid to be recirculated through prim cartridge 46 to inhibit the collection of settled particles or pigments in print cartridge 46 and to mix such fluid. In one embodiment, print cartridge 46 is removable. In another embodiment, cartridge 46 is fixed as part of system 24, wherein other components, such as its print heads, may be removable or replaceable. Print cartridge 46 includes body 88, filter 89, print head assembly 90, back pressure regulator 92 and valve assembly 94.

Body 88 comprises a structure configured to contain fluid and to support the remaining components of print cartridge 46. Body 88 includes an outer housing 100, a divider wall 102 and a back pressure regulator mount 104. Outer housing 100 provides the overall containment of fluid and supports print head assembly 90. Outer housing 100 includes an inlet 108 and an outlet 110. Inlet 108 is fluidly connected to inlet 64 and valve 40 by fluid conduit 112. Outlet 110 is connected to recirculation system 48.

Divider wall 102 is formed within the interior of outer housing 100 and divides the interior of outer housing 100 into an upper chamber 114 and a lower chamber 116. Divider wall 102 fluidly isolates or separates chambers 114, 116 such that fluid flows through and across filter 89 in order to pass from upper chamber 114 to lower chamber 116. Upper chamber 114 is in fluid communication with inlet 108 while lower chamber 116 is in fluid communication with outlet 110. Upper chamber 114 contains back pressure regulator 92. Lower chamber 116 extends across print head assembly 90. In the example illustrated, lower chamber 116 includes a print head assembly portion 111 and chimney portion 113. Print head assembly portion 114 extends across the backside of print head assembly 90. Chimney portion 113 extends from portion 111 in a general vertical direction to outlet 110. Although upper chamber 114 and lower chamber 116 are illustrated as having the depicted configurations, in other embodiments, upper chamber 114 or chamber 116 may have other shapes or fluid path configurations.

Back pressure regulator mount 104 comprises structure extending from outer housing 100 within upper chamber 114 that is configured to mount or support back pressure regulator 92. Mount 104 may have a variety of different configurations depending upon the configuration of back pressure regulator 92.

Filter 89 comprises a screen, membrane or other filtering structure extending across a fluid passenger opening 118 between upper chamber 114 and lower chamber. Filter 89 is configured to allow fluid to pass through opening 118 while blocking the passage of unwanted particles or contaminants. Filter 89 assists in preventing unwanted particles within the fluid from flowing from upper chamber 114 into lower chamber 116 where such particles may be brought into contact with print head assembly 90. In other embodiments, filter 89 may be omitted.

Print head assembly 90 comprises one or more print heads supported by outer housing 100 of body 88 and that are configured to be supplied with fluid within body 88. Print head assembly 90 is further located adjacent to lower chamber 116 such that fluid circulating through lower chamber 116 during non-printing periods crosses print head assembly 90. The circulation of fluid across print head assembly 90 reduces particle or pigments settling and further assists in clearing out or removing any previously settled particles or pigments from locations proximate to print head assembly 90. As a result, the health of print head assembly 90 is maintained for enhanced print quality.

In the example illustrated, print head assembly 90 comprises an array or series of one or more print heads configured to collectively span a dimension, such as a width, of print media. Sometimes referred to as a page wide array (PWA) print head, print head assembly 90 provides enhanced printing or fluid deposition speed. Due to the increased length or extent of print head assembly 90, fluid must flow a greater distance, rendering print head assembly 90 more susceptible to pigment or particle settling. However, system 24 addresses this issue by providing for fluid circulation across print head assembly 90 to reduce the extent of settled particles proximate to print head assembly 90. In other embodiments, print head assembly 90 may alternatively have a shorter length or dimension, wherein print head assembly 90 is a scanner moved relative to a medium being printed upon.

In one embodiment, print head assembly 90 comprises one or more drop-on-demand thermoresistance inkjet print heads. In another embodiment, print head assembly 90 may comprise one or more piezo resistive drop-on-demand inkjet print heads. In yet other embodiments, print head assembly 90 may have other configurations.

Back pressure regulation system 92 comprises a mechanism configured to regulate or control fluid back pressure within cartridge 46. Back pressure regulation system 92 provides a fluid back pressure to prevent unintended leakage or drool of fluid through print head assembly 90. At the same time, back pressure regulation system 92 establishes a back pressure that is small enough such that it may be overcome when fluid is to be ejected or printed onto a medium.

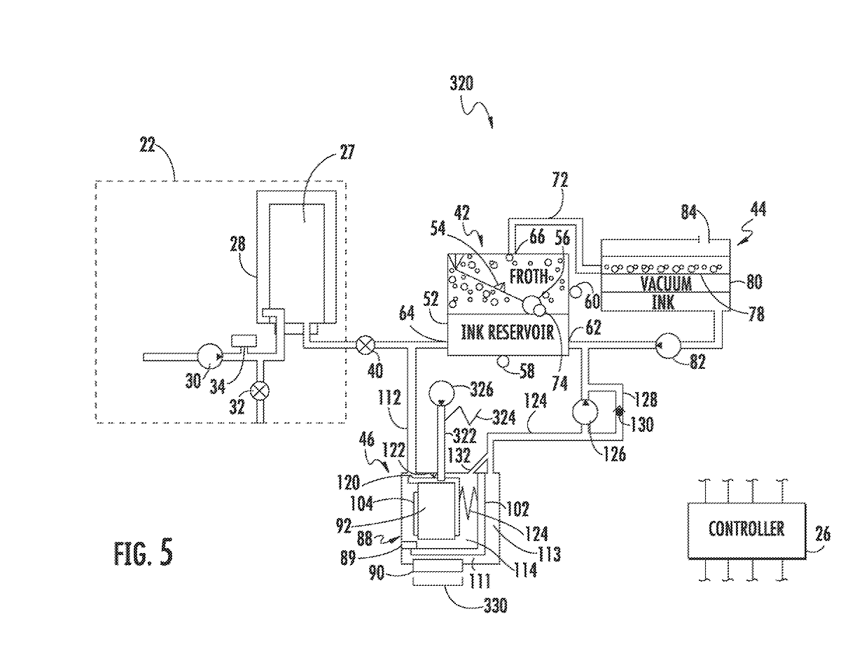

In the example illustrated, back pressure regulation system 92 comprises an inflatable bag disposed within upper chamber 114. The amount of back pressure of fluid within cartridge 46 is controlled by the extent to which the bag is inflated. In one embodiment, the inflatable bag may be fluidly connected to a pump (such as shown in FIG. 5) to adjust the degree of inflation. As shown in FIG. 1, the bag of back pressure regulator 92 is mounted within upper chamber 114 by mount 104. In other embodiments, back pressure regulator 92 may have other configurations. For example, in another embodiment, back pressure regulator 92 may comprise one or more masses of capillary material contained within upper chamber 114 which provide back pressure by resisting withdrawal of fluid. In yet other embodiments, the back pressure regulation system may comprise a stake frame back pressure regulator.

Valve assembly 94 comprises a mechanism configured to selectively open and close inlet 108. In particular, valve assembly 94 is configured to open inlet 108 to permit circulation of fluid into upper chamber 114, through lower chamber 116 and out outlet 110 during non-printing periods. Valve assembly 94 is further configured to close inlet 108 during printing periods.

In the example illustrated, valve assembly 94 includes valve 120, pivot 122 and bias 124. Valve 120 comprises a plug or stopper configured to move between an inlet closing position (shown in FIGS. 1 and 2) and an inlet opening position (shown in FIG. 3). In the example illustrated, valve 120 pivots between the closing position and the opening position. In particular, valve 120 pivots about a fulcrum provided by pivot 122. Bias 124 resiliency biases valve 120 to the inlet closing position.

In the example illustrated, bias 124 comprises a compression spring. In other embodiments, bias 124 may comprise other types of springs and may have other locations. In still other embodiments, other mechanisms may be used to pivot or otherwise move valve 120 between the closing position and the opening position. For example, in other embodiments, valve 120 may alternatively be supported by a resiliently bendable flapper or living hinge, wherein valve 120 has an at rest closing position but may be bent or flexed to an opening position.

Overall, valve assembly 94 provides a less complex and low-cost valve mechanism which automatically opens and closes based upon fluid forces in response to whether or not fluid is being circulated through print cartridge 46. In other embodiments, valve assembly 94 may have other configurations. For example, in other embodiments, valve assembly 94 may alternatively include a powered valve which opens and closes directly in response to control signals from controller 26.

Recirculation system 48 comprises an arrangement of conduits, pumps and other components configured to circulate fluid from print cartridge 46 back to air-fluid separator 42. Recirculation system 48 includes fluid conduit 124, pump 126, bypass 128, check valve 130 and air passage 132. Fluid conduit 124 comprises a fluid passage extending from outlet 110 of cartridge 46 to port 62 of reservoir 52.

Pump 126 is located along conduit number 124 and is configured to pump fluid from lower chamber 116 through outlet 110 into reservoir 52 through port 62. In the example illustrated, pump 126 is configured to create a sufficient flow of fluid through lower chamber 116 across print head assembly 90 so as to inhibit pigment settling. Pump 126 is further configured to create a sufficient flow of fluid within chambers 114 and 116 so as to overcome the bias provided by bias 124. As a result, upon actuation upon 126, valve 120 automatically moves from the closing position to the opening position. In one embodiment, pump 126 comprises a peristaltic pump. In other embodiments, pump 126 may comprise other pump configurations.

Bypass 128 comprises a fluid passage extending from conduit 124 around pump 126. Check valve 130 is located within bypass 128. Check valve 130 permits fluid flow in a single direction from outlet 110 towards port 62. Bypass 128 and check valve 130 permit excess fluid pressure within print cartridge 46 to be relieved such that a more controlled fluid pressure may be achieved within cartridge 46. In particular, check valve 130 has a cracking pressure such that fluid within print cartridge 46 will not reach pressures that may cause fluid to drool through print head assembly 90, such as if pump 126 provides too much fluid flow.

Air passage 132 comprises a passage extending from upper chamber 114 to conduit 124. Air passage number 132 is connected to the interior of upper chamber 114 proximate to a top of chamber 114. Passage 132 permits air, which rises to the top of chamber 114, to be subsequently siphoned off through passage 132 to conduit 124 and to be removed from upper chamber 114 during recirculation. Air passage 132 is proportionally smaller than conduit number 124 and outlet 110 such that air much more readily flows through passage 132 while, at the same time, fluid less readily flows through air passage 132.

According to one example embodiment, passage 132 is dimensioned relative to conduit number 124 such that air flows through passage 132 approximately 10 times faster than the rate of fluid within chamber 114 may flow through conduit 124. Approximately five times as much fluid will flow through conduit 124 as the flow of fluid through passage number 132. Passage 132 assists in removing trapped air from upper chamber 114. By removing air from fluid prior to printing, printing performance may be enhanced.

Controller 26 comprises one or more processing units configured to direct the operation of fluid supply 22, froth removal system 44, print cartridge 46 and recirculation system 48. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 26 may be embodied as part of one or more application-specific integrated circuits (ASICs). Unless otherwise specifically noted, the controller is not limited to any specific combination of hardware circuitry and software, nor to any particular source for the instructions executed by the processing unit.

As schematically shown by FIG. 1, controller 26 is in communication with each of pump 30, valve 32, sensor 34, valve 40, sensors 58, 60, pump 82, print head array 90 and pump 126. In one embodiment, controller 26 communicates via a wired connection. In another embodiment, such communication may occur wirelessly or through a combination of wired and wireless connections. In particular embodiments, controller 26 may include separate controller units dedicated to portions of system 20 which communicate with one another. For example, in one embodiment, fluid supply 22 may include its own controller 26, wherein a separate controller is utilized for printing and circulation system 24.

FIGS. 1-4 illustrate the overall operation of printing system 20. FIG. 1 illustrates printing system 20 in a non-printing state in which reservoir 52 is supplied with printing fluid from fluid supply 22. In particular, when fluid supply within reservoir 52 is low, float 56 fails with the level of fluid within reservoir 52. Upon sufficient proximity between sensor element 74 and sensor 58, signals are transmitted to controller 26 indicating a low-level state. In response, controller 26 generates control signals opening valve 40. Controller 26 further generates control signals causing pump 30 to pump air into container 28 or to open valve 32 based upon the sensed pressure within container 28 from sensor 34. As a result, fluid supply 22 supplies fluid under a desired pressure through valve 40 to reservoir 52 as indicated by arrows 200.

The supply of fluid to reservoir 52 continues until the level of fluid within reservoir 52 rises to a point such that sensor element 74 is in sufficient proximity to sensor 60 such that a signal is transmitted to controller 26 indicating that reservoir 52 is sufficiently full. Upon receiving a signal from sensor 60 that the level of fluid 52 is sufficiently full, controller 26 generates control signals closing valve 40. At such time, depending upon whether printing is taking place, controller 26 may generate control signals initiating recirculation of fluid through print cartridge 46.

During filling of reservoir 52, valve 120 is in the closing position, such that fluid from fluid supply 22 is first received within separator 42. In other words, the pressure at which fluid is supplied by supply 22 is insufficient to move valve 120 to the opening position. Consequently, any entrained air or froth is given time to escape or be separated within separator 42. The froth which rises to the top during the filling of reservoir 52 flows through conduit 72 into froth removal system 44. In froth removal system 44, separated air is vented through vent opening 84. During such time, pump 126 is not active. During such time, controller 26 may or may not be generating control signals directing print head assembly 90 to deposit or printing fluid already contained within print cartridge 46 onto a print medium or substrate.

FIG. 2 illustrates printing system 20 during a printing time period. During such time, valve 40 is closed. In addition, valve 120 is also closed. Controller 26 generates control signals direct print head assembly 90 to selectively eject fluid onto a printing medium or substrate close to form a pattern or image on the printing medium or on the substrate. Depending upon the accumulation of fluid within froth removal system 44, controller 26 may generate control signals directing pump 82 to pump separated fluid back to reservoir 52.

FIG. 3 illustrates operation of valve 54 to inhibit or prevent flow of fluid from reservoir 52 into froth separator 44. At certain times, additional fluid may flow into reservoir 52 from froth removal system 44. This may cause a level of fluid within reservoir 52 to rise above a sensor 60. As shown by FIG. 3, when this happens, float 56 rises with the level of fluid until valve 54 is moved to the closed state, closing port 66. As a result, fluid is not permitted to flow into froth removal system 44. When the level of fluid within reservoir 52 falls, valve 54 automatically moves to the open state, once again permitting troth above the fluid level to flow into froth removal system 44. Overall, valve 54 provides a less complex and less expensive system for automatically responding to changes in the level of fluid within reservoir 52 to inhibit the overflow of fluid into froth removal system 44.

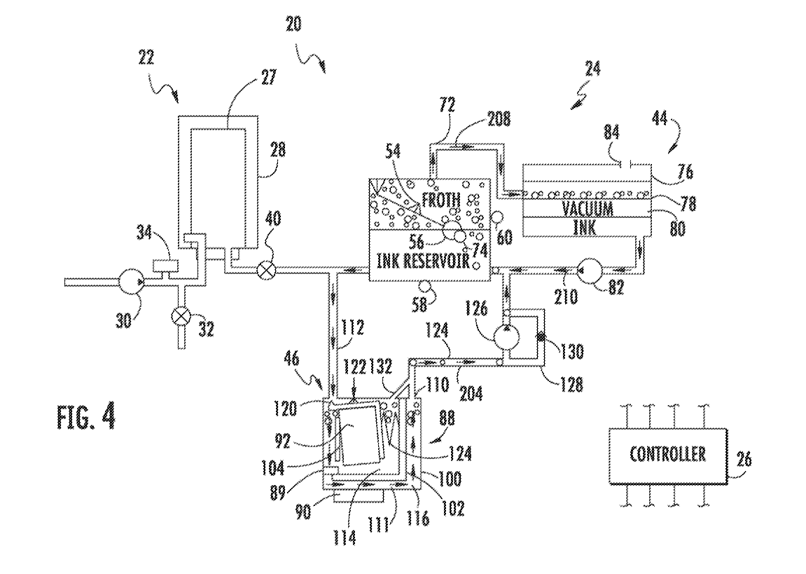

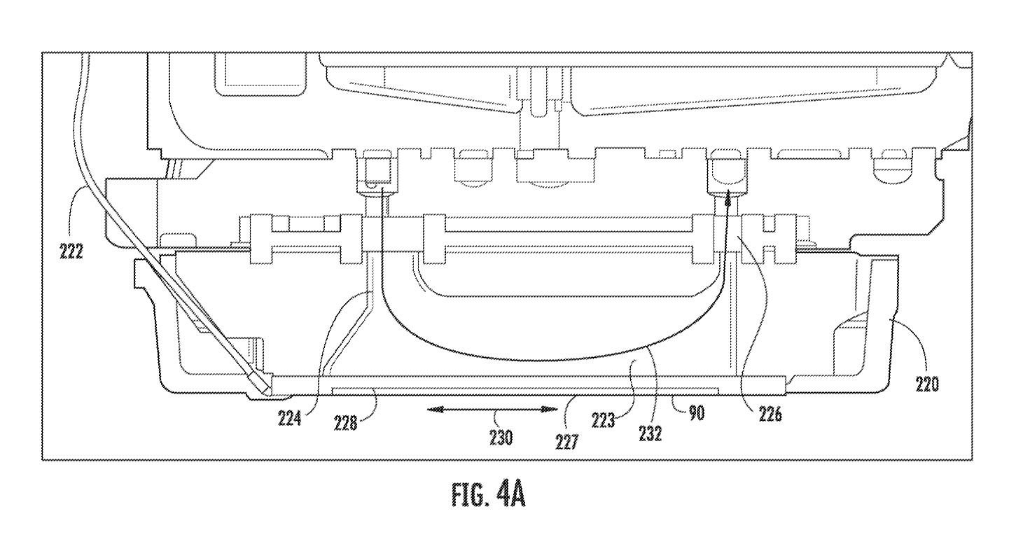

FIG. 4 illustrates printing system 20 during circulation of fluid through print cartridge 46. In particular, during non-printing periods of time, controller 26 may maintain valve 40 in a closed state. Controller 26 further generates control signals directing pump 126 to pump fluid from lower chamber 116 to reservoir 52 as indicated by arrows 204. In the example illustrated, fluid is withdrawn from lower chamber 116 at a rate sufficient such that valve 120 pivots about pivot 122 against bias 124 to the opening position shown. Consequently, a continuous uninterrupted circuit of fluid flow is formed from print cartridge 46 to reservoir 52 and from reservoir 52 to print cartridge 46. The circulation of fluid mixes the fluid to keep suspended particle components of the fluid from settling. The circulation of fluid also inhibits the collection of unsettled pigments or particles at undesirable locations in print cartridge 46.

FIG. 4A illustrates one example of body 88 and print head assembly 90. FIG. 4A further illustrates the circulation of fluid across print head assembly 90. As shown by FIG. 4A, body 88 includes a lower plenum 220 which supports print head assembly 90 as well as a flexible circuit 222 by which the electrical signals are transmitted to print head assembly 90. Plenum 220 includes a plenum chamber 223 having an inlet port 224 through which fluid flowing from filter 89 (shown in FIG. 4) enters chamber 223 and an outlet port 226 through which fluid is discharged from chamber 223 into the chimney portion of lower chamber 116. Chamber 223 includes one or more slots or passages extending across a back face of print head assembly 90.

In one embodiment, print head assembly 90 comprises a substrate or die 227 having a plurality of fluid feed slots 228 which are in fluid communication or fluidly connected to firing chambers of print not shown) which contain tiring actuators (not shown) and are opposite to nozzle openings (not shown). In thermoresistive print heads, such actuators may comprise resistors which are heated. In piezo resistive print heads, the firing chambers are bordered by a flexible diaphragm which moves to expel fluid through the nozzle openings.

In one embodiment, the fluid feed slots 228 of print head assembly 90 extend parallel to one another and generally in the direction indicated by arrows 230, parallel to the fluid circulation path across print head assembly 90 which is indicated by arrow 232. Because the fluid feed slots 228 of print and assembly 90 are parallel to the general direction of fluid circulation across print head assembly 90, a large percentage of fluid within the fluid feed slots 228 of print and assembly 90 are disturbed or mixed, reducing pigment or particle settling any remaining particles that are not disturbed may be removed during purging of fluid from print and assembly 90, such as during priming or spitting. In other embodiment, the orientation of the fluid feed slots 228 of print and assembly 90 may alternatively stand transverse to the general direction of fluid flow between inlet port 224 and outlet port 226. In other embodiments, body 88 and print head assembly 90 may have other configurations.

During such recirculation, air within fluid contained within upper chamber 114 rises. This air along the top of container 100 is drawn through air passage 132 directly to conduit 124. As schematically shown in FIG. 4, the removed air is pumped through conduit 124 to reservoir 52. In reservoir 52, the air rises and flows through conduit 72 (as indicated by arrows 208) to froth removal system 44. Once in froth removal system 44, the air is vented through vent opening 84 to atmosphere out to a condenser or to other air handling devices. Any liquid or fluid separated from the froth and system 44 is pumped by pump 82 (in response to control signal from controller 26) back to reservoir 52 is indicated by arrows 210. Once printing is to be resumed, such circulation of fluid is terminated by controller 26, returning printing system 20 to the state shown in FIG. 2,

FIG. 5 schematically illustrates printing system 320, another embodiment of printing system 20. Printing system 320 is similar to printing system 120 except that printing system 320 actuates valve 120 in a different fashion as compared to system 20. As shown by FIG. 5, system 120 additionally includes air conduit 322, labyrinth vent 324 and pump 326. The remaining components of printing system 320 which correspond to printing system 20 are numbered similarly.

Air conduit 322 extends between pump 326 and the interior of the regulator bag serving as back pressure regulator 92. Pump 326 is configured to pump air into the bag of regulator 92. Vent 324 is configured to permit deflation of the regulator bag of regular 92 In operation, controller 26 generates control signals directing pump 326 to inflate bag of regulator 92 such that the inflation of the bag of regular 92 pivots or withdraws valve 120 away from inlet 108, permitting fluid to circulate through upper chamber 114, across print head assembly 90 in lower chamber 116 and through outlet 110. When controller 26 ceases pumping by motor 326, air within bag of regulator 92 is vented to atmosphere via vent 324, wherein bag of regulator 92 resumes regulating fluid back pressure in subsequent printing.

FIG. 5 further illustrates purging of fluid through nozzles of print head assembly 90. In particular, during purging, controller 26 generates control signals directing pump 326 to inflate bag 92 so as to move valve 122 the opening position. Controller 26 further generates control signals opening valve 40. During such purging, pump 126 is not in operation to inhibit the flow of fluid past pump 1.26. As a result, fluid from the supply 22, under pressure, flows into print cartridge 46 and drives ink through nozzles of print head assembly 90. As further shown by the FIG. 5, printing system 320 additionally includes a cap, waste fluid receptacle or absorbent web 330 into which the ejected or purged fluid may be collected. By purging such fluid through the nozzles of print assembly 90, printing system 320 may remove or eject non-ink shipping fluid and clear the nozzles of print head assembly of blockages.

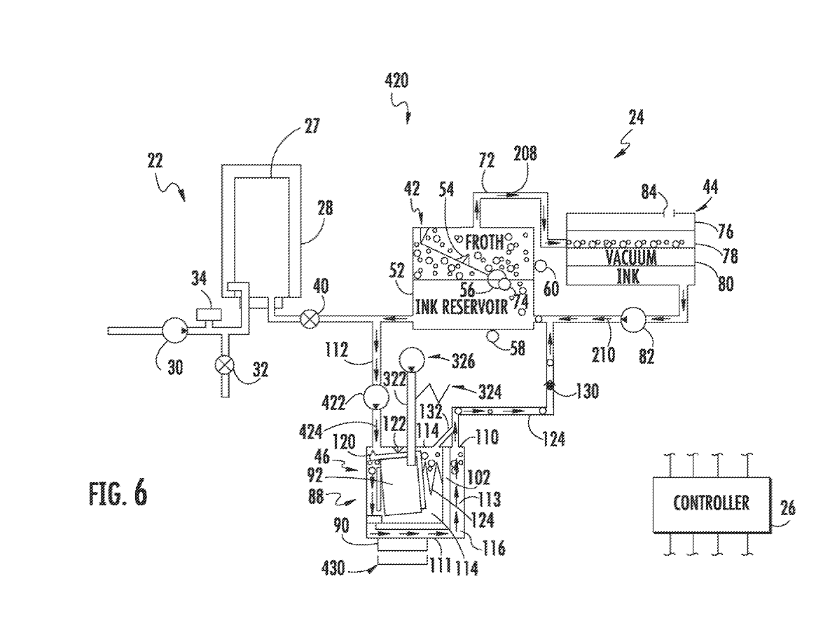

FIG. 6 illustrates printing system 420, another embodiment of printing system 20. Printing system 420 is similar to printing system 320 except that printing system 420 additionally includes pump 422 and omits pump 126 (shown in FIGS. 1 and 5). Those remaining components of system 420 that are similar to components of systems 20 and 320 are numbered similarly. Pump 422 comprises a pump fluidly connected along the fluid conduit 112. Pump 422 is configured to pump fluid through inlet 108.

FIG. 6 illustrates printing system 420 during recirculation of fluid through print cartridge 46. During such circulation, controller 26 generates control signals directing pump 422 to push fluid through inlet 108 rather than pulling fluid through cartridge 46 as was previously performed by pump 126. In one embodiment, opening of valve 120 may be performed solely in response to the pressure applied by the fluid being pumped by pump 422 against valve 120. In another embodiment, valve 120 may be opened by controller 26 generating control signals directing pump 326 to inflate the bag of regulator 92 so as to force valve 122 to the opening position. In other embodiments, the movement of valve 120 to the opening position may be achieved by the combination of both pumps 326 and 422. As indicated by arrows 424, fluid is circulated across print head assembly, through conduit 124 and back to ink reservoir 52. Entrained air is further pumped from lower chamber 116 through outlet 110 while air within upper chamber 114 is ejected through air passage 132 through conduit 124. The air is carried to reservoir 52 where it rises and passes to froth removal system 44 as indicated by arrows 208. Once again, the separated air is vented through vent opening 84 while the separated fluid is pumped by pump 82 back to reservoir 52 as indicated by arrows 210.

As further shown by FIG. 6, system 420 additionally includes cap 430. Cap 430 is configured to seal or close the nozzles of print head assemblies 90 during such circulation. Cap 430 allows fluid to flow across print assembly 90 without being purged or ejected through the nozzle openings of print head assembly 90. In other embodiments, 430 may be replaced with an absorbent web or other waste fluid receiving vessel, wherein purging is concurrently performed with circulation.

Overall, systems 20, 320 and 420 provide effective and less complex systems for actively removing air from the fluid without generating much waste fluid. At the same time, such systems provide for circulation to mix the fluids and reduce pigment or particulate settling. As a result, optical density of the fluid is maintained and the nozzles of print head assembly 90 are less likely to become clogged, enhancing printing performance.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a cartridge comprising:
a body having an inlet, an outlet, an upper chamber in fluid communication with the inlet and a lower chamber including communication with the outlet;
a print head assembly supported by the body adjacent the lower chamber such that fluid flowing through the lower chamber is circulated across the print head assembly.
a back pressure regulator within the upper chamber; and
a valve, wherein the valve is configured to close the inlet during ejection of fluid by the print head assembly and is configured to open the inlet to permit circulation of fluid into the upper chamber through the inlet and outlet the lower chamber through the outlet.

2. The apparatus of claim 1 further comprising a filter between the upper chamber and the lower chamber.

3. The apparatus of claim 1 further comprising a pump configured to draw fluid through the outlet, wherein the valve opens in response to pumping of the fluid by the pump.

4. The apparatus of claim 1, wherein the back pressure regulator comprises a regulator bag within the upper chamber, wherein the apparatus further comprises an air pump pneumatically coupled to the regulator bag, and wherein actuation of the valve is in response to an extent of inflation of the bag.

5. The apparatus of claim 4 further comprising a labyrinth vent to atmosphere pneumatically coupled to the regulator bag.

6. The apparatus of claim 1 further comprising a pump configured to push fluid through the inlet.

7. The apparatus of claim 1 further comprising an actuator configured to selectively open and close the valve.

8. The apparatus of claim 1 further comprising:
a fluid supply;
a froth filter having an inlet, and outlet and a vent; and
a fluid reservoir having a first port in communication with the fluid supply, a second port in communication with the outlet of the cartridge body and an upper discharge port in communication with the inlet of a froth filter and configured to direct froth from the fluid reservoir to the froth filter.

9. The apparatus of claim 8 further comprising a fluid reservoir valve configured to open and close the upper discharge port based upon a level of fluid as compared to troth in the fluid reservoir.

10. The apparatus of claim 9 further comprising a float connected to the fluid reservoir valve, wherein the fluid reservoir valve pivots in response to movement of the float.

11. The apparatus of claim 1 further comprising an air path in communication with the upper chamber and connected to a fluid circulatory path extending from the outlet.

12. The apparatus of claim 11, wherein the air path is configured such that fluid flow through the outlet has a greater rate as compared to fluid flow through the air path.

13. The apparatus of claim 1, wherein the print head assembly includes one or more print heads configured to, collectively, span a width of a print medium.

14. A method comprising:
circulating fluid across one or more print heads during non-printing periods, and
inhibiting circulation of fluid across the one or more print heads during printing periods.

15. The method of claim 14, wherein the fluid is circulated through an inlet leading to the one or more print heads and wherein the method further comprises;
occluding an inlet during the printing periods; and
pumping fluid to circulate the fluid across the one or more print heads, wherein the inlet is opened in response to pumping of the fluid.

16. The method of claim 14 wherein the fluid is circulated through an inlet leading to the one or more print heads and wherein the method further comprises:
inflating a regulator bag to include the inlet during the printing periods; and
deflating the regulator bag to open the inlet to circulate the fluid across the one or more print heads.

17. The method of claim 14 further comprising:
circulating the fluid from the one or more print heads to a fluid reservoir;
circulating froth in the fluid reservoir to a froth filter;
circulating fluid recovered from a froth filter to the fluid reservoir; and
circulating fluid from the fluid reservoir to the one or more print heads during the non-printing periods.

18. The method of claim 17 further comprising interrupting the circulation of froth to the froth filter based upon a level of fluid as compared to froth in the fluid reservoir.

19. The method of claim 18, wherein the interrupting of the circulation of froth to the froth filter is in response to movement of a float within the fluid reservoir.

20. An apparatus comprising:
means for circulating fluid across one or more print heads during non-printing periods; and
means for inhibiting circulation of fluid across the one or more print heads during printing periods.
